(19) United States
(12) Patent Application Publication
(10) Pub. No.: US 2013/0009005 A1
(43) Pub. Date: Jan. 10, 2013

(54) REVERSE THRUST DEVICE

(75) Inventor: Pierre Caruel, Le Havre (FR)

(73) Assignee: AIRCELLE, Gonfreville L'Orcher (FR)

(21) Appl. No.: 13/635,951

(22) PCT Filed: Mar. 25, 2011
(86) PCT No.: PCT/FR2011/050657

§ 371 Date: Sep. 19, 2012

(30) Foreign Application Priority Data
Mar. 25, 2010 (FR) 10/52192

(51) Int. Cl. F02K 1/72

(52) U.S. Cl. 244/110 B

(57) ABSTRACT

The invention relates to a reverse thrust device including a stationary upstream structure including a front frame (30) and a cowl (40). Said cowl (40) is extended by a nozzle (41) with a variable cross-section and is translatable between a deployed position, causing a variation in the cross-section of the nozzle (41), and a retracted position, wherein the nozzle (41) is in a position wherein it ensures aerodynamic continuity of the cowl (40). Said device is remarkable in that at least part of the front frame (30) is translatable with the cowl (40) during the movement thereof to a position causing a variation in the nozzle cross-section.

### TECHNICAL FIELD

The present invention relates to a thrust reverse device for an aircraft nacelle. The invention also relates to a nacelle comprising such a device and a method implemented by such device.

### BRIEF DESCRIPTION OF RELATED ART

An airplane is moved by several turbojet engines each housed in a nacelle also housing the set of related actuating devices connected to its operation and performing various functions when the turbojet engine is running or stopped.

These related actuating devices in particular include a mechanical thrust reverse system.

More specifically, a nacelle generally has a tubular structure including an air intake upstream of the turbojet engine, a middle section designed to surround a fan of the turbojet engine, a downstream section housing the thrust reverse means and designed to surround the combustion chamber of the turbojet engine, and generally ending with a jet nozzle situated downstream of the turbojet engine.

This nacelle is designed to house a dual flow turbojet engine capable, by means of the rotating blades of the fan, of generating a hot air flow, coming from the combustion chamber of the turbojet engine, and a cold air flow that circulates outside the turbojet engine through an annular channel called a tunnel.

The thrust reverse device is designed to improve the braking capacity of the aircraft during landing thereof by reorienting at least part of the thrust generated by the turbojet engine forward.

During this phase, the thrust reverse device obstructs the cold air flow tunnel and orients the latter toward the front of the nacelle, thereby generating a counter-thrust that is added to the braking of the wheels of the aircraft, the means implemented to perform that reorientation of the cold air flow varying depending on the type of reverser.

However, in all cases, the structure of a reverser comprises a movable cowl that can be moved between a deployed position in which it opens a passage in the nacelle designed for the deflected airflow on the one hand, and a retracted position in which it closes the passage on the other hand.

This cowl may perform a cascade function, or simply a function activating other cascade means.

In the case of a cascade vane reverser, the air flow is reoriented by cascade vane(s), associated with reverser flaps, the cowl only performing a simple sliding function aiming to expose or cover said cascade vanes.

The reverser flaps form blocking doors that can be activated by sliding the cowl, causing closure of the tunnel downstream of the vanes, so as to optimize the reorientation of the cold air flow.

In a known manner, the cascade vanes are attached to the case of the turbojet engine and the middle section of the nacelle using a front frame.

Furthermore, aside from its thrust reversal function, the sliding cowl belongs to the rear section and has a downstream side forming the jet nozzle aiming to channel the discharge of the airflows.

The optimal section of the discharge nozzle may be adapted as a function of the different flight phases, i.e. the takeoff, ascent, cruising, descent, and landing phases of the airplane.

It is associated with an actuating system making it possible to vary and optimize its section as a function of the flight phase in which the airplane is operating.

The variation of that section, illustrating the section variation of the cold air flow tunnel, is done through a partial translation of the mobile cowl.

However, aerodynamic losses have been observed, in particular during the movement of the cowl upstream toward the stationary structure of the thrust reverse device to return to its retracted position, at the interface between the moving cowl and the stationary structure including the front frame, as well as the placement of pressure of the cowl.

These aerodynamic losses are due to a mismatch between the surfaces upstream and downstream of the interface between the moving cowl and the front frame.

Tight machining allowances to reduce these losses and ensure the aerodynamic continuity of the stationary structure and the cowl when said structure is covered by the cowl and the relative deformations between the cowl and the front frame make the interface between the cowl and the front frame difficult to control.

Furthermore, a frequent risk of damage to the seals designed to seal the cold air flow tunnel, placed between the moving cowl and the front frame to be compressed when the moving cowl is translated into its retracted position, has also been observed, which decreases the sealing quality of the tunnel.

### BRIEF SUMMARY

One aim of the present invention is to resolve these drawbacks.

To that end, the invention proposes a thrust reverse device having an upstream structure including a front frame and a cowl, said cowl being extended by a nozzle with a variable cross-section and being translatable between at least one deployed position, causing a variation in the cross-section of the nozzle, and a retracted position, wherein the nozzle is in a position wherein it ensures aerodynamic continuity of the cowl, said device being remarkable in that at least part of the front frame is translatable with the cowl during the movement thereof to a position causing a variation in the nozzle cross-section.

Owing to the invention, the geometric allowances and the relative deformations between the moving cowl and the stationary structure including the front frame have less of an impact during the movement of said cowl to vary the cross-section of the nozzle, inasmuch as the cowl no longer moves in relation to the front frame during operation in the nozzle variation mode, and the functional play between those two parts can be chosen to have a smaller value.

According to specific embodiments of the invention, a device according to the invention may include one or more of the following features, considered alone or in any technically possible combinations:
the entire front frame is translatable with the cowl when it is moved toward a position causing the variation in the cross-section of the nozzle;
the front frame including a covering panel with a fan case and a cascade edge, said panel and at least part of the cascade edge are translatable with the cowl when it is moved to a position causing a variation in the cross-section of the nozzle;
the front frame is mounted on at least one guide rail placed in the plane of the covering panel;
the front frame can move away from the cowl when the cowl moves to a position ensuring a thrust reversal of the device.

The invention also relates to a nacelle including a thrust reverse device as previously stated and a fan case remarkable in that the fan case includes an extension structure upstream of the front frame adapted to at least partially receive the covering panel and ensure the movement thereof inside the extension structure.

According to specific embodiments of the invention, a nacelle according to the invention may include one or more of the following features, considered alone or according to all technically possible combinations:
the extension structure has dimensions adapted to allow longitudinal movement of the inner covering panel upstream and downstream in relation to the position of the front frame corresponding to the retracted position of the cowl;
the interface between the covering panel and the extension structure includes sliding sealing means;
the nacelle also includes a removable axial stop adapted to limit the downstream movement of the covering panel;
the nacelle also includes removable means for locking the cowl and the front frame.

The invention also relates to a method implemented with a thrust reverse device as previously cited in which at least part of the front frame is moved when the cowl is moved to a position causing a variation in the cross-section of the nozzle.

### BRIEF DESCRIPTION OF THE DRAWINGS

Other features, aims, and advantages of the present invention will appear upon reading the following detailed description, according to embodiments provided as non-limiting examples, and in reference to the appended drawings, in which:

FIG. 1 shows a partial cross-sectional view of the nacelle of an aircraft according to the present invention;

FIG. 2 is a cross-sectional view of a first embodiment of a thrust reverse device according to the present invention;

FIGS. 3 and 4 are respectively cross-sectional views of second and third embodiments of a thrust reverse device according to the present invention;

FIGS. 5, 5b, 5c and 6 are cross-sectional views of a thrust reverse device according to FIG. 2, wherein the nozzle has a reduced, normal, increased, and reverse jet cross-section, respectively;

FIGS. 7 to 9 illustrate cross-sectional views of successive steps of a maintenance method for a thrust reverse device according to the invention;

FIGS. 10a and 10b are an alternative embodiment of FIGS. 7 to 9.

### DETAILED DESCRIPTION

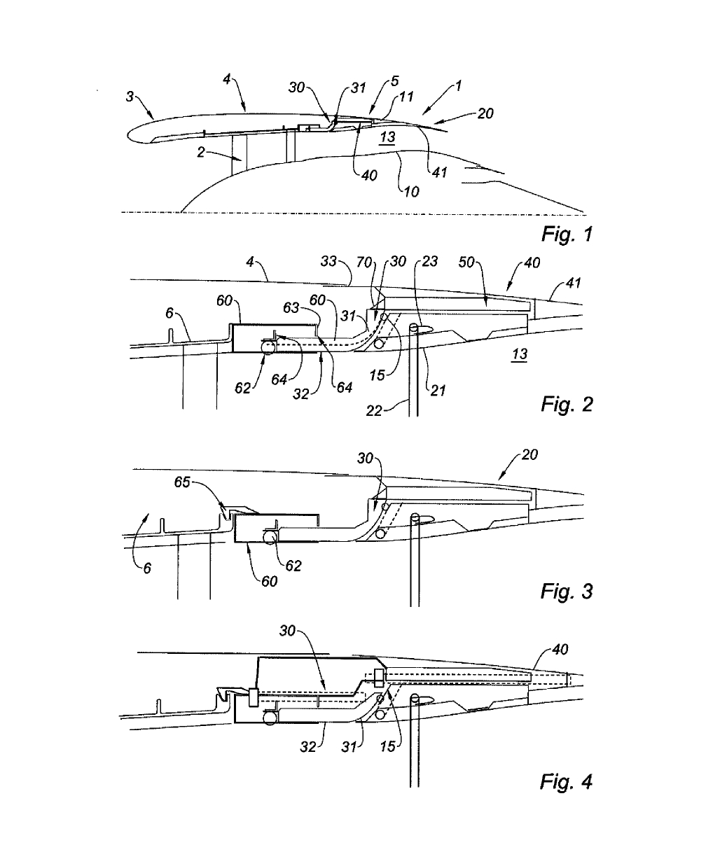

In reference to FIG. 1, a nacelle 1 is designed to make up a tubular housing for a dual flow turbojet engine and serves to channel the air flow it generates by means of the blades of a fan 2, i.e. a hot air flow passing through a combustion chamber and a cold air flow circulating outside the turbojet engine.

The nacelle 1 generally has a structure including an upstream section 3 forming an air intake, a middle section 4 surrounding the fan of the turbojet engine, and a downstream section 5 surrounding the turbojet engine.

The downstream section 5 includes an outer structure 11 comprising a thrust reverse device 20 and an inner engine fairing structure 10 defining, with the outer structure 11, a tunnel 13 designed for the circulation of a cold flow in the case of the dual flow turbojet engine nacelle as presented here.

The downstream section 10 also includes a front frame 30, a moving cowl 40, and a jet nozzle section 41.

As illustrated in FIG. 1, the front frame 30 is extended by a cowl 40 slidingly mounted along the longitudinal axis of the nacelle.

The front frame 30 supports a plurality of cascade vanes (not shown) housed in the thickness of the moving cowl 40, when the latter is in the closed position.

The front frame 30 includes a front panel (not shown) designed to fasten the middle section of the nacelle to a structural element (not shown), called a conical shell, belonging to the front frame. The structural element may enable fire resistance.

The front frame 30 also comprises a cascade edge element 31 ensuring the aerodynamic line.

This element 31 is extended at both ends by covering panels 32, 33 providing covering between the front frame 30 and the fan case 6 and the middle section of the nacelle 4, respectively. These panels will be described in more detail in reference to FIG. 2.

The interface between the front frame 30 and the moving cowl 40 is traditional and known by those skilled in the art.

In particular, a sealing device 15 is placed at the interface between the front frame 30 and the upstream portion of the cowl 40 (see FIG. 2).

The moving cowl 40 is designed to be actuated in a substantially longitudinal direction of the nacelle 1 between a closed position, in which it partially covers the front frame 30 and ensures the aerodynamic continuity of the external lines of the downstream section 10, and an open position, in which it is spaced away from the front frame 30, then opening a passage in the nacelle by exposing the airflow cascade vanes.

It traditionally slides along the beam (not shown) or engine mast supporting the turbojet engine (not shown), depending on the configuration of the nacelle 1.

The passage allows the secondary flow of the turbojet engine to be at least partially discharged, said flow portion being reoriented toward the front of the nacelle 1 by the cascade vanes, thereby generating a counter-thrust capable of helping the braking of the airplane.

In order to increase the secondary flow portion passing through the vanes, the thrust reverse device 20 includes a plurality of reverser flaps 21, distributed over the circumference of the inner cowl 40 of the reverser 20, and each pivotably mounted by one end around a hinge pin, on the cowl 40 sliding between a retracted position, in which the flap 21 closes the opening and ensures the inner aerodynamic continuity of the tunnel 13, and a deployed position, in which, in the thrust reversal situation, it at least partially covers the tunnel 13 in order to deflect a gas flow toward the vanes.

Such an installation may be done traditionally using a set of connecting rods 22 ending with a spring leaf 23.

During the direct thrust operation of the turbojet engine, the sliding cowl 40 forms all or part of a downstream portion of the nacelle 1, the flaps 21 then being retracted into the sliding cowl 40, which covers the vane passage.

During a phase for varying the cross-section of the nozzle, the reverser flaps 21 can remain in the retracted position when the moving cowl 40 has moved by the travel necessary to vary the cross-section of the nozzle 41, and begin their pivoting beyond that point only when the spring 23 is completely compressed.

To reverse the thrust of the turbojet engine, the sliding cowl 40 is moved into the downstream position and the flaps 21 pivot into the covering position so as to deflect the secondary flow toward the vanes and form a reversed flow guided by the vanes.

Furthermore, as previously mentioned, the sliding cowl 40 has a downstream side forming the jet nozzle 41 aiming to channel the discharge of the air flows.

The optimal section of the discharge nozzle 41 may be adapted as a function of the different flight phases, i.e. the takeoff, ascent, cruising, descent, and landing phases of the airplane.

This cross-section is varied, illustrating the cross-section variation of the cold air flow tunnel, through a partial translation of the moving cowl 40.

The moving cowl 40 can thus be moved into a position for varying the cross-section of the nozzle, i.e. at least one position decreasing the cross-section of the nozzle and a position increasing the cross-section of the nozzle.

In one alternative embodiment of the present invention, the nozzle 41 may include a series of moving panels rotatably mounted at a downstream end of the moving cowl 40 and distributed on the periphery of the jet nozzle cross-section 41.

Each panel is adapted on the one hand to pivot toward a position causing a variation in the cross-section of the nozzle 41 and, on the other hand, to pivot toward a position in which they ensure the aerodynamic continuity of the cowl.

Each panel is supported by the moving cowl 40 by means of pivot points along an axis perpendicular to the longitudinal axis of the nacelle with the inner portion of the moving cowl 40 and with said moving panel.

The passage from one position of a mobile panel to the other is controlled by actuating means connected to the panel by means of a drive system 60, for example made up of driving rods.

The actuating means 50 can activate the movement of the moving cowl 40 as well as the pivoting of the panel toward a position causing a variation in the cross-section of the nozzle 41.

These actuating means 50 and the drive system are known by those skilled in the art and will not be described in more detail hereafter.

The moving cowl 40 may thus be moved using a rail/slide system known by those skilled in the art, or any other adapted actuating means 50 including at least one electric, hydraulic or pneumatic linear actuator.

According to the invention, at least part of the front frame 30 is translatable with the cowl 40 when it is moved toward a position causing a variation in the cross-section of the nozzle 41.

More specifically, the front frame 30 is adapted to slide in concert with the moving cowl 40 between the extreme positions for varying the cross-section and to move away from the cowl 40 when the cowl 40 is moved toward the thrust reverse position.

Two independent actuating systems may be considered, or a single system capable of independently moving the front frame 30 or the moving cowl 40, for example such as a telescoping jack.

As illustrated in FIG. 2 in a first embodiment of the present invention, the entire front frame 30, including the covering panels 32, 33 with the fan case 6 as well as the cascade vanes, is translatable.

Advantageously, such a sliding front frame 30 does not modify its interface with the moving cowl 40, in particular to manage the sealing and the positioning allowances.

The interface between the front frame 30 and the fan case 6 is as follows.

As illustrated in FIG. 2, the interface between the fan case 6 and the moving front frame 30 slides with covering ensured by the aforementioned covering panels 32, 33.

More specifically, the fan case 6 is extended, in the inner portion thereof, in the downstream direction by an extension system 60 so as to ensure covering with the moving front frame 30 and, in particular, the inner covering frame 32 of the front frame 30.

This extension structure 60 has a generally rectangular cross-section with a downstream opening adapted for the passage of the internal covering panel 32 of the front frame 30.

The dimensions of the extension structure 60 are adapted to allow longitudinal movement of the internal covering panel 32 upstream and downstream in relation to the position of the front frame 30 corresponding to the position of the cowl 40 associated with the nominal cross-section.

A sliding seal 62 ensures sealing between the extension structure 60 of the fan case 6 and the moving front frame 30. This seal 62 is extended up to the seal situated between the moving cowl 40 and the front frame 30, and slides along the engine mast (not shown).

In one alternative embodiment, the extension structure 60 also includes an axial stop 63 in order to prevent the front frame 30 from moving beyond a position corresponding to a position of the cowl 40 allocated to a maximum increase of the cross-section of the nozzle 41 and to react the axial forces resulting from the reverse jet vanes.

This stop 63, with a generally I-shaped cross section, is placed at the opening necessary for the passage of the internal covering panel 32 of the front frame 30.

It is designed to cooperate with a profile 64 secured to the L-shaped sliding sealing device 62, one branch of which abuts against a corresponding portion of the axial stop 63 on the downstream portion of the extension structure 60, making any additional movement of the front frame 30 impossible.

Such a stop 63 advantageously allows the front frame 30 to remain in contact with the extension structure 60 of the fan case 6 during thrust reverse phases for which the cowl 40 is translated further downstream, so as to allow the reverser flaps 21 to pivot into a position covering the cold flow tunnel 13 and the complete release of the passage toward the cascade vanes.

Owing to the present invention offering a front frame 30 that is translatable during the phases for varying the cross-section of the nozzle 4, the geometric allowances and relative deformations between the moving cowl 40 and the stationary front structure of the state of the art no longer disrupt the closing of the cowl 40 on the front frame 30, since the latter moves partially with the cowl 40 in the phases for varying the cross-section of the nozzle.

Furthermore, the sliding parts necessary to vary the cross-section of the nozzle are simplified relative to the state of the art; since the interface between the moving front frame 30 and the extension 60 of the fan case 6 is still engaged, the seal 62 ensuring sealing is thus still compressed, including in reverse jet operation.

The risks of damage to the sealing devices are thus reduced.

To move in translation, the front frame 30 may be mounted on at least one rail placed in the plane of the vanes and, preferably, on two rails, one of which is placed in the plane of the internal covering panel 32.

Each rail can slide directly on the engine mast so as to allow the retraction of the vanes in the event the reverser structure is made in a single piece and must be translated to provide access to the engine equipment.

In one alternative embodiment, two rails are placed in the upper and lower beams.

The front frame 30 includes actuating means adapted to actuate the front frame 30 in relation to the fan case 6 or a piece secured thereto.

These actuating means are known by those skilled in the art and will not be described in detail. Non-limiting examples include hydraulic, pneumatic or electric actuators, or driving rod screws.

As previously stated, the moving cowl 40 may be actuated either in relation to the fan case, or preferably in relation to the front frame 30.

In the latter configuration, the actuators of the moving cowl 40 remain immobile during the phase for varying the variable nozzle, and the cowl 40 moves in concert with the front frame 30 owing to the means for actuating the front frame 30.

In one alternative embodiment, the moving cowl 40 may be locked in relation to the front frame 30 in direct jet operation, and for all positions of the nozzle, so as to keep two lines of defense when faced with untimely triggering of thrust reversal during flight.

The moving front frame 30 and the moving cowl 40 may thus be connected by conventional locking means 70 of the type locking in the actuator or hooks connecting the two structures.

Such locking means 70 are adapted to lock the moving cowl 40 with the front frame 30 during phases for varying the cross-section of the nozzle 41 in direct jet operation, and to free the moving cowl 40 in reverse jet operation during thrust reversal.

In an alternative embodiment illustrated in FIG. 3, in which the thrust reverse device 20 is made up of two half-reversers, the extension structure 60 of the fan case 6 is secured to the beams of the reverser.

Its upstream portion includes a blade 65 with an upside down U-shaped cross-section allowing it to be housed in a groove borne by the fan case 6.

The sliding seal 62 ensuring sealing between the extension of the fan case 6 and the moving front frame 30 slides along the upper and/or lower bifurcation.

In reference to FIG. 4, a second embodiment proposes that only part of the front frame 30 is translatable with the moving cowl 40, i.e. the internal covering panel 32 and the portion of the cascade edge 31 defined as far as the sealing joint 15 between the front frame 30 and the cowl 40.

The size of the moving front frame 30 and the associated forces are thus limited, allowing a mass reduction and smaller actuators for the front frame 30 in the case where the actuators of the moving cowl 40 are not connected thereto.

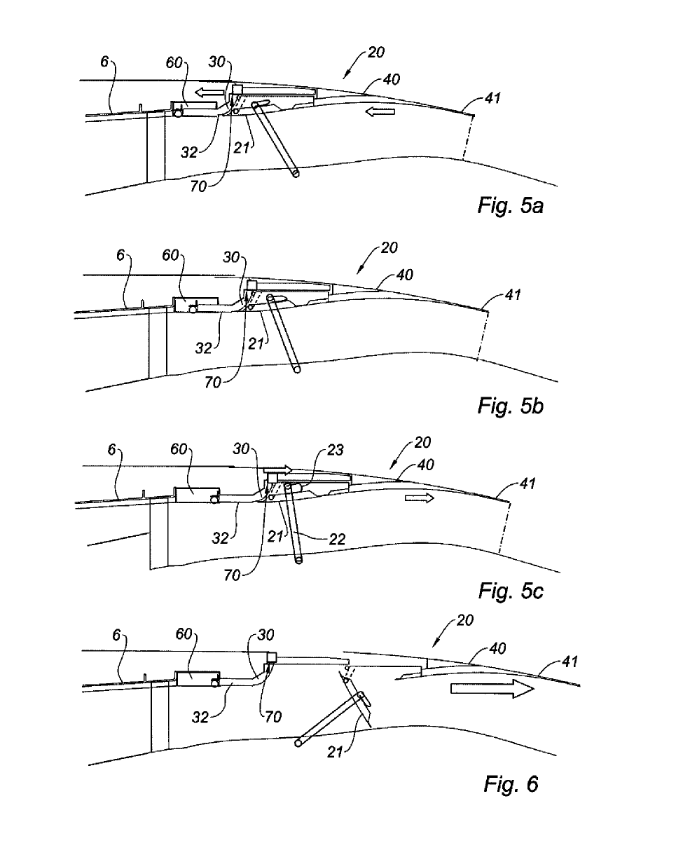

In reference to FIGS. 5a, 5b, 5c and 6, the operating principle of the thrust reverse device 20 according to the invention is as follows.

In direct jet operation and the nozzle 41 being in the normal cross-section position, i.e. ensuring the aerodynamic continuity of the cowl 40, the cowl 40 is in the closed position ensuring the aerodynamic continuity with the front frame 30. It is locked with the latter (FIG. 5b) using the aforementioned locking means 70.

During a phase for decreasing the cross-section of the nozzle 41 illustrated in FIG. 5a, the moving cowl 40 moves toward the upstream of the nacelle, causing a decrease in the cross-section of the nozzle 41. At the same time, the front frame 30, locked with the moving cowl 40, also moves toward the upstream of the nacelle, the internal covering panel 32 moving in the extension structure 60 of the fan case 6.

The flaps 21 retain their position ensuring the aerodynamic continuity of the inner cowl 40.

During a phase for increasing the cross-section of the nozzle 41 illustrated in FIG. 5c, the principle is similar to FIG. 5a with the exception that the cowl 40 and the front frame 30 move toward the downstream direction of the nacelle.

The compression variation of the spring 23 of the driving rod 22 of the flap 21 makes it possible to accommodate the translation of the latter by preventing the opening thereof.

In reverse jet operation, as illustrated in FIG. 6, the front frame 30 is in a position abutting against the extension structure 60 of the fan case 6.

The cowl 40 is released from the front frame 30 by disengaging the locking means 70, so as to allow its additional movement toward the downstream of the nacelle into a position in which it exposes the cascade vanes and drives the pivoting of the thrust reversal flaps 21 in the tunnel so as to reorient the air from the tunnel toward the vanes.

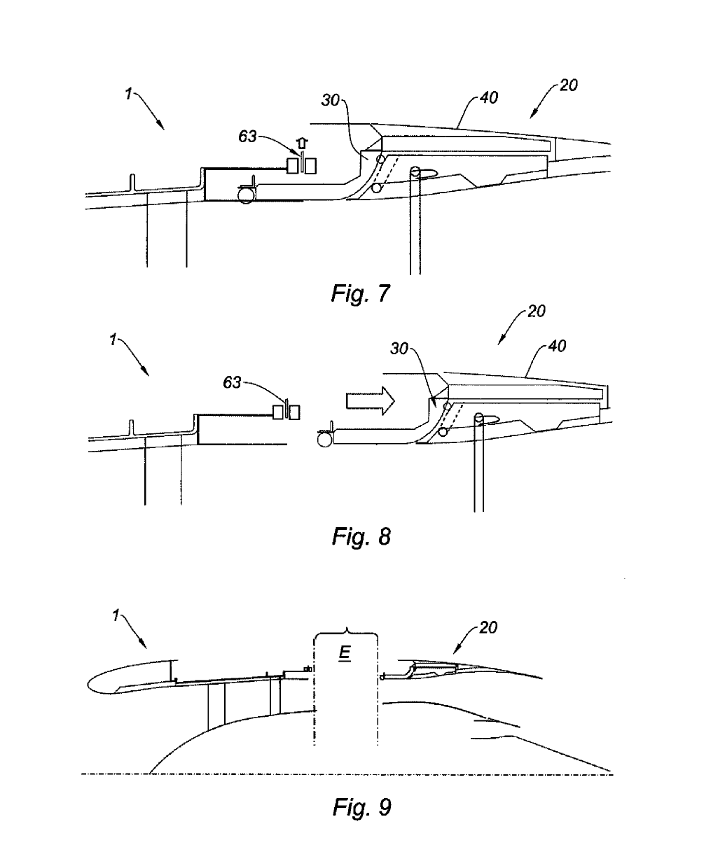

In FIGS. 7 to 9, a first embodiment of the maintenance method is shown for thrust reverse device 20 according to the invention, allowing access to the equipment housed inside the nacelle 1 for the maintenance thereof by translating all of the moving parts.

First, the assembly of the front frame 30 and the moving cowl 40, as well as the cascade vanes, is translated toward the downstream direction of the nacelle 1.

At the end of travel of the cowl 40 and the front frame 30 for varying the cross-section of the nozzle as illustrated in FIG. 7, it is necessary to disconnect the axial stop 63 as well as any power source for the actuators of the cowl 40, thereby freeing the front frame 30, which will henceforth move in concert with the cowl 40 (FIG. 8).

The movement is ensured by the travel of the actuators of the front frame 30.

An adapted space E is thus available to access the equipment of the nacelle for maintenance, as illustrated in FIG. 9.

This method offers the advantage of using the actuators already placed in the device and preserving the structural continuity of the front frame 30.

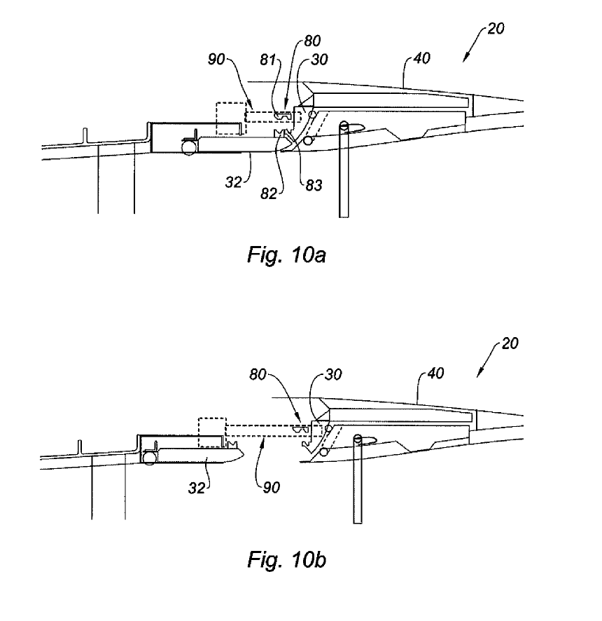

FIGS. 10a and 10b illustrate a second embodiment of a maintenance method for a thrust reverse device according to the invention.

In this method, the internal covering panel 32 is separated from the rest of the front frame 30 to access the equipment of the nacelle.

To that end, a separation is done at a removable axial interface 80 of the assembly type, including an upside down U-shaped structure 81 cooperating with several grooves 82, 83 respectively formed by the internal covering panel 32 and the front frame 30 by engagement, as illustrated in FIG. 10a.

It is then necessary to disconnect any power source for the actuators of the cowl 40.

As illustrated in FIG. 10b, the assembly of the front frame 30 without the internal covering panel 32, moving cowl 40, and cascade vanes is translated toward the downstream direction of the nacelle 1 using an actuating system dedicated to maintenance and known by those skilled in the art of the actuator 90 type.

Preferably, this maintenance actuator 90 is placed near or even in the hinge pin of the U-shaped structure 80, so as not to interfere with the trajectory of that structure 80 during opening or closing of the cowl 40.

This embodiment offers the advantage of segregating the variable nozzle function from the maintenance function and preserving bearing of the sliding sealing device, even during maintenance operations, to limit the risk of damage.

1. A thrust reverse device having an upstream structure including a front frame and a cowl, said cowl being extended by a nozzle with a variable cross-section, said cowl being translatable between at least one deployed position, causing a variation in a cross-section of the nozzle, and a retracted position, wherein the nozzle is in a position wherein it ensures aerodynamic continuity of the cowl, wherein at least part of the front frame is translatable with the cowl during movement thereof to a position causing a variation in the nozzle cross-section.

2. The device according to claim 1, wherein the entire front frame is translatable with the cowl when it is moved toward a position causing the variation in the cross-section of the nozzle.

3. The device according to claim 1, wherein the front frame including a covering panel with a fan case and a cascade edge, said panel and at least part of the cascade edge are translatable with the cowl when it is moved to a position causing a variation in the cross-section of the nozzle.

4. The device according to claim 3, wherein the front frame is mounted on at least one guide rail placed in the plane of the covering panel.

5. The device according to claim 1, wherein the front frame can move away from the cowl when the cowl moves to a position ensuring a thrust reversal of the device.

6. A nacelle including a thrust reverse device according to claim 3 and a fan case 6, wherein the fan case includes an extension structure upstream of the front frame adapted to at least partially receive the covering panel and ensure the movement thereof inside the extension structure.

7. The nacelle according to claim 6, wherein the extension structure has dimensions adapted to allow longitudinal movement of the inner covering panel upstream and downstream in relation to the position of the front frame corresponding to the retracted position of the cowl.

8. The nacelle according to claim 6, wherein the interface between the covering panel and the extension structure includes sliding sealing means.

9. The nacelle according to claim 6, wherein it also includes a removable axial stop adapted to limit the downstream movement of the covering panel.

10. The nacelle according to claim 6, wherein it also includes removable means for locking the cowl and the front frame.

11. A method implemented with a thrust reverse device according to claim 1, wherein at least part of the front frame is moved when the cowl is moved to a position causing a variation in the cross-section of the nozzle.
